(19) United States
(12) Patent Application Publication
(10) Pub. No.: US 2005/0160218 A1
(43) Pub. Date: Jul. 21, 2005

(54) Highly integrated mass storage device with an intelligent flash controller

(76) Inventors: Sun-Teck See, San Jose, CA (US); Tzu-Yih Chu, San Jose, CA (US); Ben-Wei Chen, Fremont, CA (US); Horng-yee Chou, Palo Alto, CA (US); Szu-Kuang Chou, Cupertino, CA (US); Charles C. Lee, Sunnyvale, CA (US)

Correspondence Address: SAWYER LAW GROUP LLP, P.O. Box 51418, Palo Alto, CA, 94303, US

(21) Appl. No.: 10/761,853

(22) Filed: Jan. 20, 2004

(51) Int. Cl. G06F 12/00

(52) U.S. Cl. 711/103

(57) ABSTRACT

A FLASH controller is disclosed. The controller comprises a USB interface unit. The USB interface unit implements a USB standard that has a bus speed equal or greater than 12 Mb/s. The controller includes an internal bus coupled to the USB interface unit; and a FLASH interface unit coupled to the internal bus. The FLASH interface unit includes FLASH controller logic that allows the throughput for access to the FLASH memory to match the speed of the USB standard. Advantages of the FLASH controller in accordance with the present invention include (1) utilizing the higher speed USB interface such as the USB 2.0 standard, which substantially increases the serial throughput between USB host and FLASH controller; (2) utilizing more advanced FLASH control logic which is implemented to raise the throughput for the FLASH memory access; (3) utilizing an intelligent algorithm to detect and access the different FLASH types, which broadens the sourcing and the supply of FLASH memory; (4) by storing the software program along with data in FLASH memory which results in the cost of the controller being reduced, and also makes the software program field changeable and upgradeable; and (5) providing high integration, which substantially reduces the overall space needed and reduces the complexity and the cost of manufacturing.

### FIELD OF THE INVENTION

The present invention relates generally to mass storage devices and more particularly to a highly integrated mass storage device with an intelligent FLASH controller.

### BACKGROUND OF THE INVENTION

A removable mass storage device includes a FLASH controller and one or more FLASH memories. It has replaced a floppy disk because it is smaller in size and has a higher storage capacity when utilized with a computing device, such as a personal computer, notebook computer, laptop computer or other portable device. FIG. 1 is a block diagram of a conventional mass storage device 10. The mass storage device 10 includes a FLASH controller 12 which is coupled to a bus 11 such as a USB bus. The USB bus 11 is a shared bus; accordingly, the bandwidth is allocated among multiple active devices attached to the bus. The maximum speed of the USB1.x standard is 12 Mb/s, which is much slower than the throughput of the contemporary NAND FLASH memory.

The FLASH controller 12 includes a USB serial interface unit 14 and a FLASH interface unit 16. The USB serial interface unit includes a transceiver (XCVR) block 18, a serial interface engine (SIE) block 20, data buffers 22, registers 24 and interrupt logic 40. The USB serial interface is 14 coupled to an internal bus 26 to allow for the various elements of the USB interface to communicate with the elements of the FLASH interface unit 16. The FLASH interface unit includes a microprocessor unit (MPU) 28, a ROM 30, a RAM 32, FLASH logic 34, error correction code (ECC) logic 36 and general purpose input/output (GPIO) logic 38. The GPIO logic 38 is coupled to a plurality of LEDs, write protect switch and other I/O devices 42. The FLASH logic is coupled to a plurality of FLASH memories 44.

The mass storage device 10 includes an external power regulator 52 for providing power supplies to the FLASH controller 12. The device 10 includes an external reset circuit 54 for providing a reset signal to the FLASH controller 12. The mass storage device also includes an external quart crystal oscillator 56 to provide the fundamental frequency to PLL 58 within the FLASH controller 12.

The conventional FLASH controller 12 has several problems which will be detailed below.

Integrated ROM for Software Program

The conventional FLASH controller 12 has an external ROM 46 for storing software program (including boot and control codes). After development software program is provided to the internal ROM 30 in the FLASH interface unit 16. Once the internal ROM 30 is programmed, it cannot be changed and the software program is “frozen”. Typically, the external ROM 46 is eliminated but if it remains in the mass storage device 10 it affects the compactness of the controller. The advent of new FLASH memory types and new features will always make the current FLASH controller an obsolete one. Accordingly, typically frequent development cycles are necessary which are costly and time consuming.

USB 1.X Standard

USB 1.x is an older generation of serial interface with maximum throughput of 12 Mb/s. This speed is a bottleneck compared to the speed performance of NAND FLASH memory. The contemporary NAND write speed is around 55 Mb/s and read speed is around 129 Mb/s. These speeds are apparently much faster than USB1.x standard. The progress of semiconductor process will further increase the performance of NAND and thereby the speed bottleneck will become greater.

Variety of New FLASH Types

The advance of FLASH technology has also created a greater variety of FLASH types for reasons of performance, cost and capacity. For example, a large page size (2K Bytes) FLASH memory has better write performance against a small page size (512 Bytes) FLASH memory; an Multi Level Cell (MLC) FLASH memory has higher capacity versus an Single Level Cell (SLC) FLASH memory for the same form factor; an AND or Super-AND FLASH memory has been created to circumvent intellectual property issues. To support these various FLASH memories, the FLASH interface unit must be able to detect and access them accordingly.

Compactness

Since the FLASH controller is a removable device its compactness is highly important. In addition to the FLASH controller and the FLASH memory, the external components (i.e., power regulator 52, reset circuit 54, crystal oscillator 56 and external ROM 46) also create problems when attempting to reduce the overall size of the device.

Accordingly, what is needed is a highly integrated mass storage device which includes a FLASH controller that overcomes the above-identified problems. The present invention addresses such a need.

### SUMMARY OF THE INVENTION

A FLASH controller is disclosed. The controller comprises a USB interface unit. The USB interface unit implements a USB standard that has a bus speed equal or greater than 12 Mb/s. The controller includes an internal bus coupled to the USB interface unit; and a FLASH interface unit coupled to the internal bus. The FLASH interface unit includes FLASH controller logic that allows the throughput for access to the FLASH memory to match the speed of the USB standard.

Advantages of the FLASH controller in accordance with the present invention include (1) utilizing the higher speed USB interface such as the USB 2.0 standard, which substantially increases the serial throughput between USB host and FLASH controller; (2) utilizing more advanced FLASH control logic which is implemented to raise the throughput for the FLASH memory access; (3) utilizing an intelligent algorithm to detect and access the different FLASH types, which broadens the sourcing and the supply of FLASH memory; (4) by storing the software program along with data in FLASH memory which results in the cost of the controller being reduced, and also makes the software program field changeable and upgradeable; and (5) providing high integration, which substantially reduces the overall space needed and reduces the complexity and the cost of manufacturing.

### BRIEF DESCRIPTION OF THE DRAWINGS

FIG. 1 is a block diagram of a conventional mass storage device.

FIG. 2 is a block diagram of a mass storage device in accordance with the present invention.

FIG. 2A is a diagram of 8-bit access with 8-bit data FLASH memory.

FIG. 2B is a diagram of 16-bit access with 16-bit data FLASH memory.

FIG. 2C is a diagram of 16-bit access with two 8-bit data FLASH memories via a single control.

FIG. 2D is a diagram of 16-bit access with two 8-bit data FLASH memories via separate controls.

FIG. 3A is a diagram of concurrent FLASH access design.

FIG. 3B is a diagram of concurrent read cycles.

FIG. 3C is a diagram of concurrent write.

FIG. 3D is a diagram of concurrent write/read.

FIG. 3E illustrates concurrent FLASH access design utilizing a wider data bus.

FIG. 4 is a flow chart of FLASH memory type detection.

FIG. 5 is a diagram of a basic FLASH memory cell.

FIG. 5B is a diagram of SLC and MLC.

FIG. 6A is a diagram of hardware switching.

FIG. 6B is a diagram of software switching.

FIG. 7 is an illustration of a multi chip package.

### DETAILED DESCRIPTION

The present invention relates generally to mass storage devices and more particularly to a highly integrated mass storage device with an intelligent FLASH controller. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

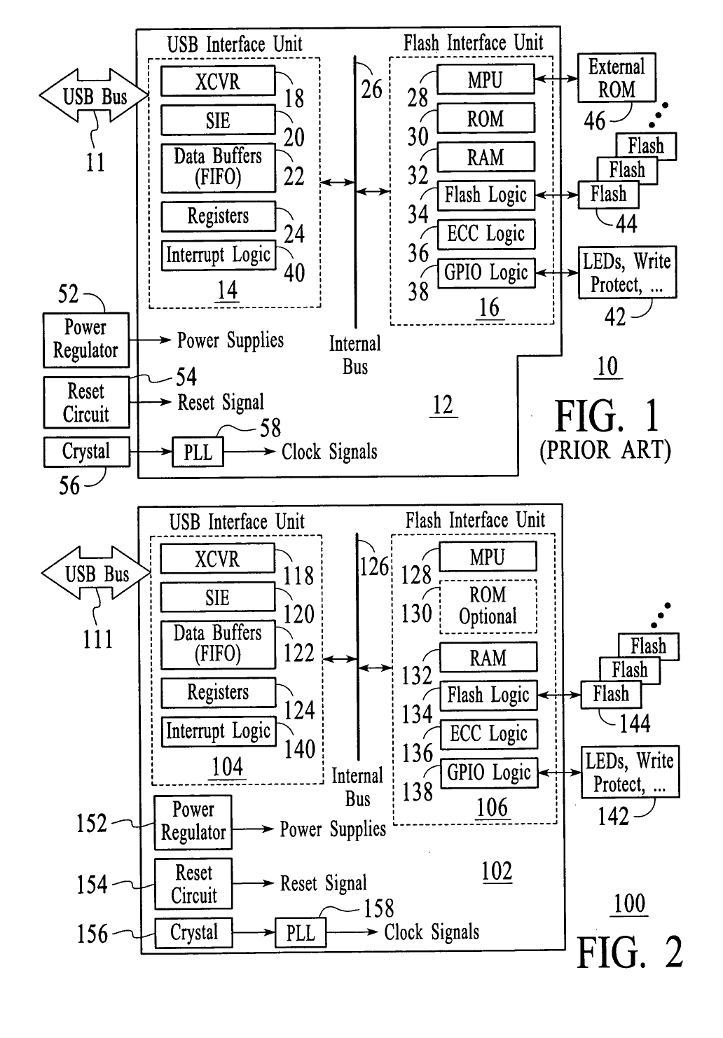

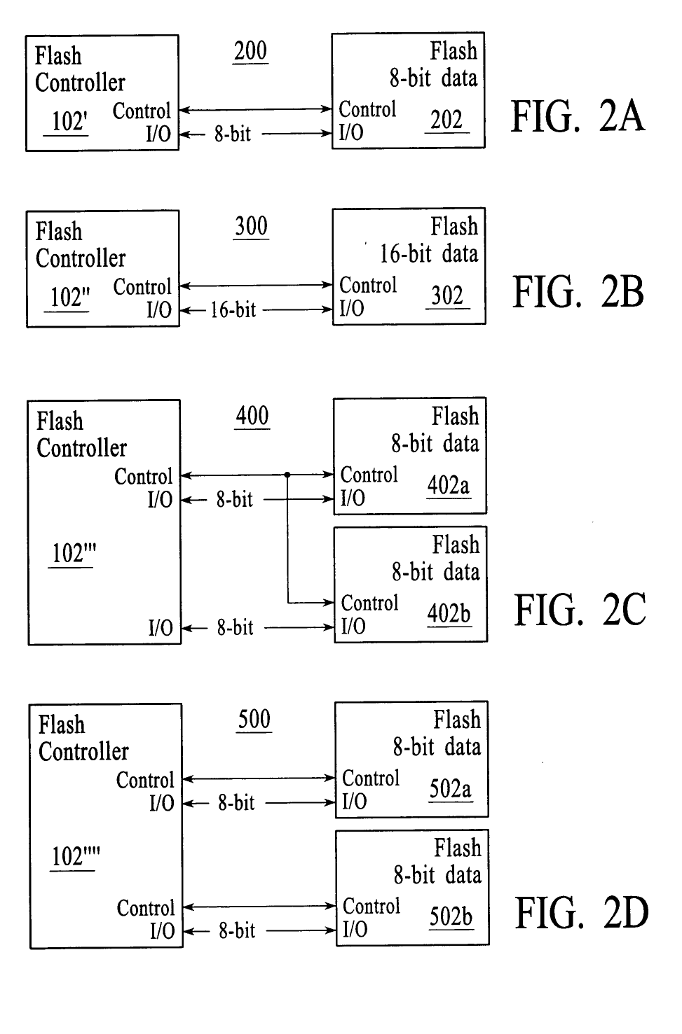

FIG. 2 is a block diagram of a mass storage 100 device in accordance with the present invention. The mass storage device 100 includes a highly integrated FLASH controller 102. As in the FLASH controller 12 of FIG. 1, the FLASH controller 102 includes a USB serial interface unit 104 and a FLASH interface unit 106. The USB serial interface unit 104 includes a transceiver (XCVR) block 118, a serial interface engine (SIE) block 120, data buffers 122, registers 124 and interrupt logic 140. The USB serial interface is 104 coupled to an internal bus 126 to allow for the various elements of the USB interface unit 104 to communicate with the elements of the FLASH interface unit 106. The FLASH interface unit 106 includes a microprocessor unit (MPU) 128, a ROM 130 (optional), a RAM 132, FLASH logic 134, error correction code (ECC) logic 136 and general purpose input/output (GPIO) logic 138. The GPIO logic 138 is coupled to a plurality of LEDs for status indication such as power good, activity, etc., write protect switch and other I/O devices 142. The FLASH logic is coupled to a plurality of FLASH memories 144.

As is seen the crystal 156, reset circuit 154, and power regulator 152 are now integrated within the FLASH controller 102 in contrast to being external components to the FLASH controller 12 of FIG. 1. The high integration substantially reduces the overall space needed, the complexity, and the cost of manufacturing. In addition, the USB bus 111 is implemented in accordance with a higher speed USB standard such as USB 2.0. The USB 2.0 standard allows for a maximum bus speed of 480 Mb/s which substantially increases the serial throughput between USB host and FLASH controller 102.

The current NAND FLASH memory speeds are around 129 Mb/s for read, 55 Mb/s for write, which is a bottleneck compared to 480 Mb/s of USB 2.0. Thus, a more advanced FLASH control logic 134 implemented in accordance with the present invention increases the throughput for the FLASH memory access. There are a number of ways to raise the throughput by the FLASH control logic and they will be described below.

A. Provide Wider Broadband Flash Memory Data Bus

A typical mass storage device 200 uses a FLASH memory 202 with an 8-bit data bus, as shown in FIG. 2A. Wider data bandwidth multiplies the access speed to the FLASH memory. For example, 16-bit data bus may double the access speed to the FLASH memory, 32-bit data may increase the access speed by 4 times, and so on. Wider data bandwidth can be realized either by using a FLASH memory with the appropriate data width, or by multiplying a lower data-width FLASH memory; e.g., mass storage device with 16-bit data width 300 can be realized by one 16-bit wide FLASH memory 302 as illustrated in FIG. 2B, by two 8-bit wide FLASH memories 402a and 402b via a single control as illustrated in FIG. 2C, or by two 8-bit wide FLASH memories 502a and 502b via separate controls as illustrated in FIG. 2D.

B. Provide Concurrent Internal and External Cycles

A NAND FLASH memory has a page register and memory array as the major building blocks. For the FLASH memory write cycle, the FLASH controller executes external write cycles to fill the page register first, then the FLASH memory will assert a busy signal and program the data from the page register into the memory array. No other access to the FLASH memory is allowed during this busy period of internal program cycle that is in the magnitude of hundreds of microseconds. For the FLASH memory read cycle, before FLASH controller 102 can execute the read cycles to fetch the data, the FLASH memory asserts a busy signal and transfers the data from the memory array to the page register. No other access is allowed during this busy period of internal transfer cycle that is in the magnitude of tens of microseconds.

With multiple FLASH memories, the concurrent execution of internal and external cycles can remove the idle time caused by the internal busy period, thereby increasing the overall throughput of the FLASH memory access.

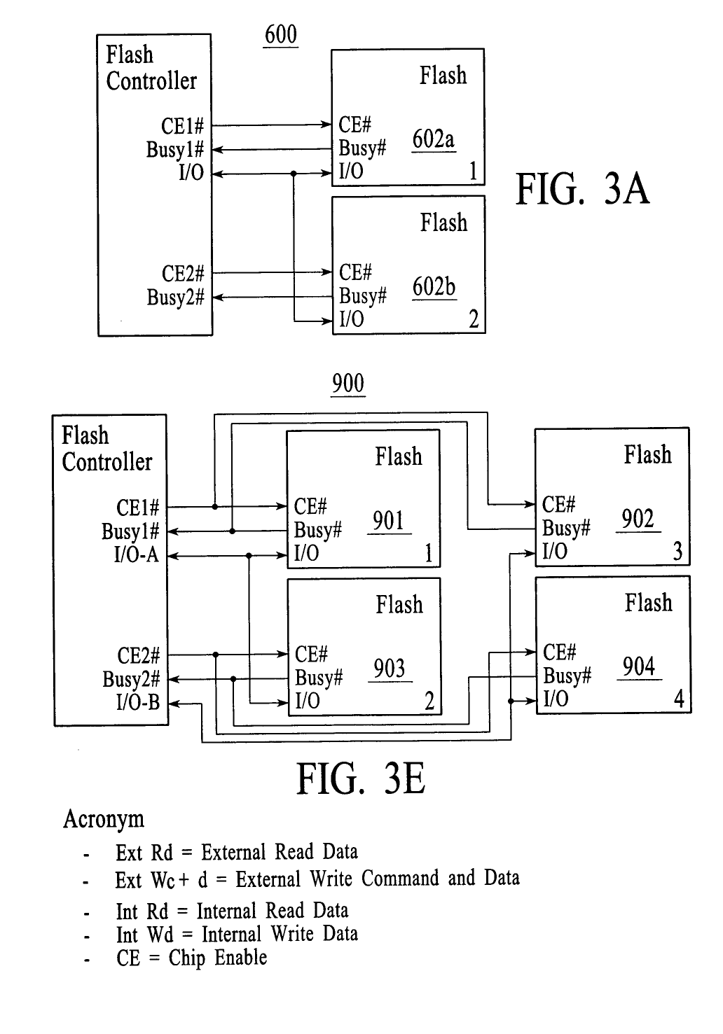

For example, referring to FIGS. 3A through 3D, when two FLASH memories 602a and 602b are installed with separate chip enable and busy signals, and with either a single 8-bit or multiple of 8-bit I/O bus, as illustrated in FIG. 3A, FLASH memory read cycles can be pipelined by reading a FLASH memory with data ready when the other FLASH memory is transferring the data from its memory array as illustrated in FIG. 3B. FLASH memory write cycles can be concurrent as well by writing to the page register of a FLASH memory while the other FLASH memory is executing the internal program cycle as shown in FIG. 3C. Alternate FLASH memory write and read cycles can be concurrent when reading a FLASH memory with data ready while the other FLASH memory is programming the data into its memory array or when writing to page register of a FLASH memory while the other FLASH memory is transferring the data from its memory array as illustrated in FIG. 3D.

C. Provide Concurrent Internal and External Cycles Upon Wider Bus

Combining the concurrent internal and external cycles with a wider data bus can further increase the throughput of the FLASH control logic. As shown in FIG. 3E, I/O-B is added to the existing I/O-A to widen the data access to the FLASH memories. FLASH memories 901 and 902 form a wider data group while FLASH memories 903 and 904 form another wider data group. Accordingly, internal and external concurrent cycles are executed between these two groups with a wider data bus. The data bus can be further widened by adding multiple I/O buses.

Intelligent FLASH Controller Algorithm

The advance of FLASH memory technology has also created a greater variety of FLASH types for reasons of performance, cost and capacity. Each manufacturer may include additional features for differentiation.

Due to the potential shortage, cost, the need for sourcing flexibility of FLASH memories, and the fact that unique control is required to access each different FLASH type, it is important to implement a FLASH controller with intelligent algorithm to detect and access the different FLASH types.

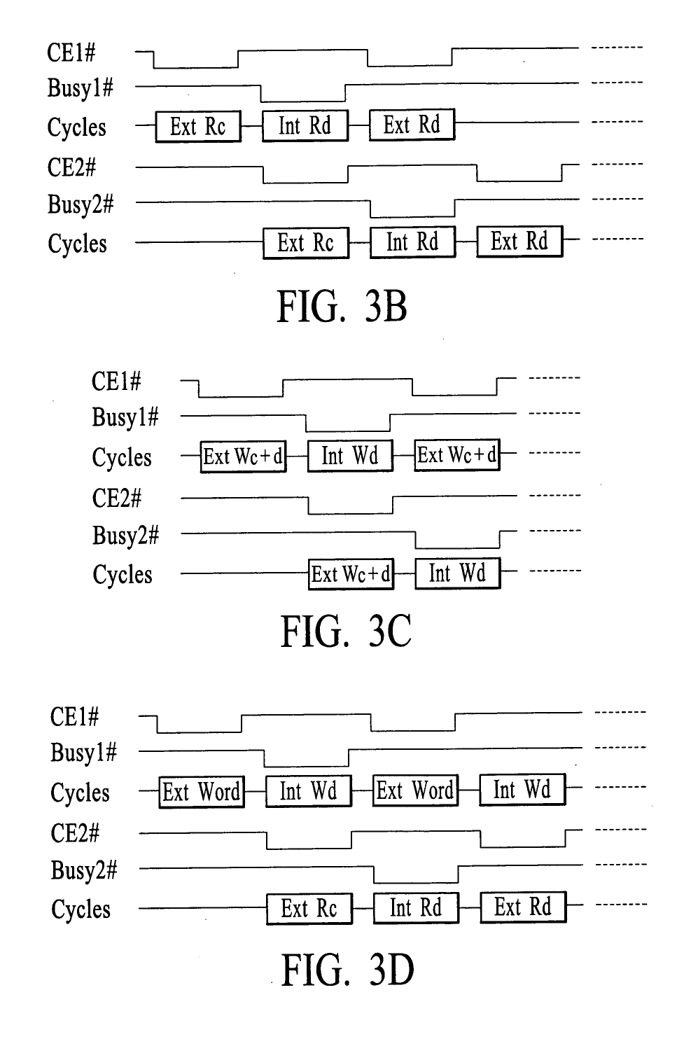

The typical FLASH memory contains ID code which identifies the FLASH type, the manufacturer, and the features of the FLASH memory such as page size, block size organization, capacity, etc. FIG. 4 illustrates a FLASH detection algorithm in accordance with the present invention. First, the FLASH controller is reset, via step 602. Next, the ID of the FLASH memory is read to identify the type of FLASH memory, via step 604. The read ID is then compared against the table of FLASH types that are supported, via step 606. If the FLASH type is not supported, the controller will not access the FLASH memory, and the incompatibility can be indicated by LED via the output port of the controller, via step 608. If the FLASH type is supported, the controller will be configured to the access mode corresponding to that detected FLASH type before the controller begins accessing the FLASH memory, via step 610.

Different FLASH Types

The following are the examples of FLASH types and the ways to access them using the FLASH controller 102 in accordance with the present invention:

A. Multi-Level Cell (MLC) Versus Single-Level Cell (SLC):

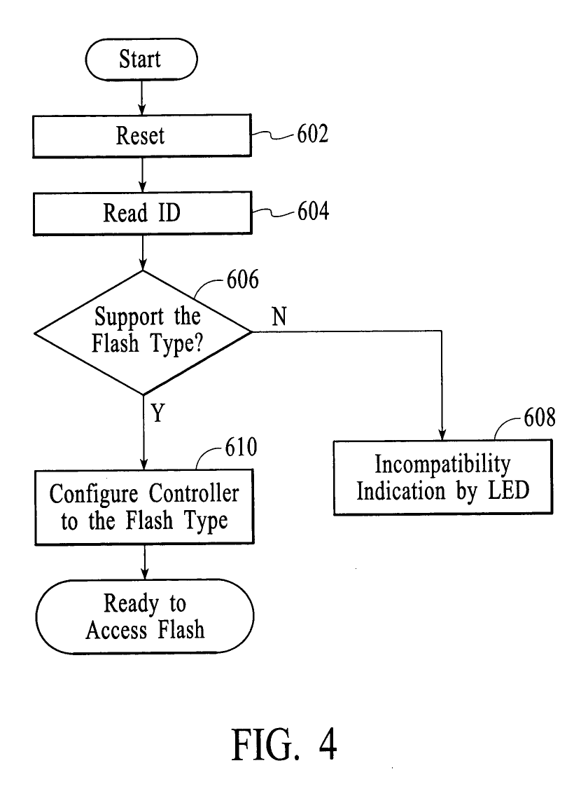

Access to an MLC FLASH memory is different from access to an SLC FLASH memory. The FLASH controller 102 needs different schemes for address decoding as well as for error code detection and correction. The basic cell in a FLASH memory is a transistor 700 as shown in FIG. 5A. Each cell is characterized by a specific threshold voltage (Vt) level. Electrical charge is stored on the floating gate of each cell.

Typical FLASH memory uses SLC technology, which has only two possible voltage levels shown at the left table in FIG. 5B, corresponding to one bit (0 or 1) data. These two levels are controlled by the amount of charge that is programmed or stored on the floating gate; if the amount of charge on the floating gate is above a certain reference level, the cell is considered to be in a different level.

MLC technology enables storage of multiple bits per memory cell by charging the floating gate of a transistor to more than two levels by precisely controlled injection of electrical charges. A two-bit MLC FLASH memory has four voltage levels as shown at the right table in FIG. 5B. A three-bit MLC FLASH memory has eight voltage levels; an N bit MLC FLASH memory has 2 to the exponential of N voltage levels.

An MLC FLASH memory effectively reduces cell area as well as the die size for a given density and leads to a significantly reduced unit cost-per-megabyte. This is important for devices such as mass storage, which has concern for space and cost.

As there are more voltage levels in an MLC FLASH memory, the enhanced ECC/EDC control logic 136 (FIG. 2) is needed to provide for data reliability and to minimize the programming time to manipulate the voltage levels.

### EXAMPLES

Toshiba (TC58DVG02A) is a 1 Gigabit SLC NAND FLASH memory with 1 bit per memory cell, the block address is A15 to A26. One bit ECC is used.
SanDisk (SDTNFCH-1024) is a 1 Gigabit MLC NAND FLASH memory with 2 bits per memory cell, the block address is A14 to A26. 4-bit ECC is recommended.
   B. Software Switching for Different Pin Definition

The pin assignments may have slight differences from different vendors for the cause of different features or architectures.

Example: Samsung K9F1G08, K9W4G08 and Toshiba TC58DVG02A are the popular NAND FLASH memories with different signal assignment at Pin 6.

| FLASH Type | Pin 6 |
|---|---|
| K9F1G08 | NC (No Connect) |
| K9W4G08 | RIB2 (Ready/Busy2) |
| TC58DVG02A | GND (Ground) |

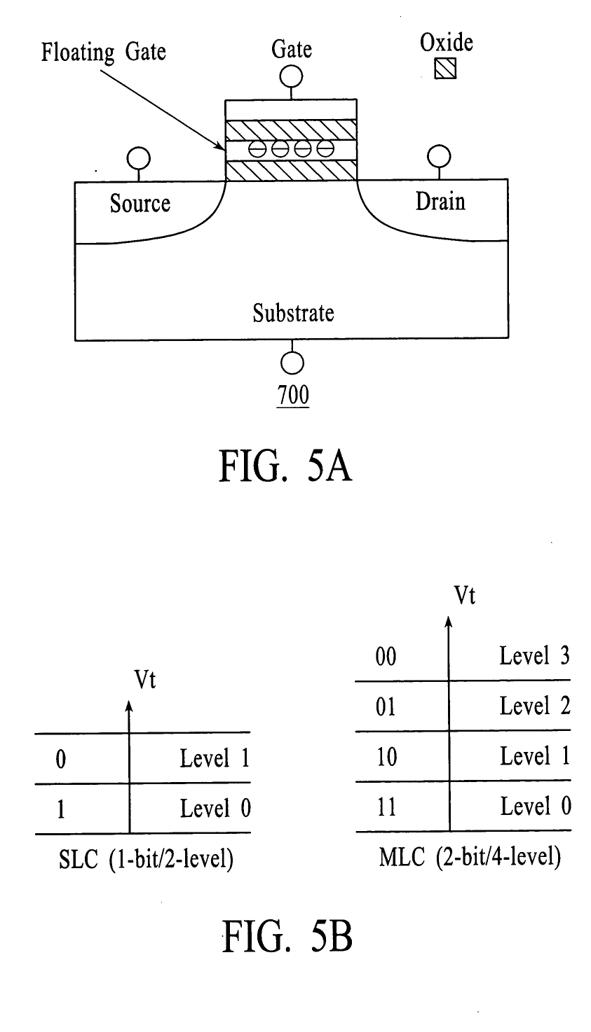

To accommodate multiple FLASH memories with different pin assignments on a same PCB is typically a difficult issue to address with the conventional FLASH controller. Conventionally, this issue is addressed by using hardware switching to select the appropriate signal connection according to the FLASH memory used. FIG. 6A shows an example with resistors 802 and 804 as the selecting switch. In a system and method in accordance with the present invention, this issue is addressed by using software switching to replace the hardware switch and further reduce the hardware space needed with the use of a general IO pin as shown in FIG. 6B. The FLASH controller 102 will set the pin assignment corresponding to the FLASH type after the detection cycle.

To Store Software Program in Flash Memory

A conventional mass storage device uses FLASH memories for data storage. A FLASH memory is a non-volatile memory that is programmable and suitable for software program storage as well. Certain NAND FLASH memories include a Power-on Auto-read feature that enables serial access of data of the first page without command and address input after power on. This feature eases the loading of the software program when powering on.

A software program typically includes boot code and control code. The software program normally has standard and dynamic sections. The standard section is a fixed code that will never change, whereas the dynamic section contains codes that will be altered according to changes in design and features etc.

By storing the software program in the FLASH memory along with data, the program is no longer frozen, the ROM can be reduced or eliminated, thereby not only the cost of the controller is reduced, but also the software program is field changeable and upgradeable. In addition, as the upgrade or modification effort is solely in software, and hardware effort is not required, the overall development cost and time is significantly reduced.

Compactness

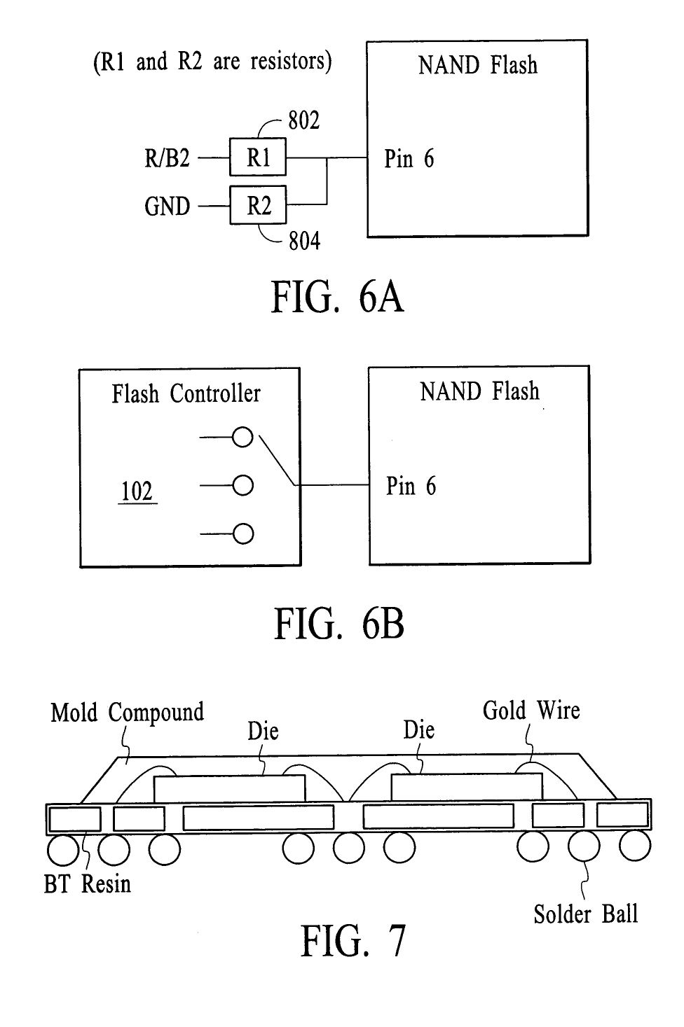

The compactness and cost are key factors to removable devices such as a mass storage device. Modem IC packaging can integrate discrete IC components with different technology and material into one IC package. For example, a MCP (Multi-Chip Package), as shown in FIG. 7, can be used to integrate together the controller and crystal that is typically composed of quartz. The reset circuit and power regulator are analog circuitry which can also be integrated into the same package with the controller.

The nature of mixed signal technology allows the hybrid integration of both analog and digital circuitry. Therefore, higher integration can be incorporated into the same die for the controller, crystal, reset circuit and power regulator.

Advantages

1. Utilizing the higher speed USB interface such as the USB 2.0 standard substantially increases the serial throughput between USB host and FLASH controller.

2. Utilizing more advanced FLASH control logic which is implemented to raise the throughput for the FLASH memory access.

3. Utilizing an intelligent algorithm to detect and access the different FLASH types broadens the sourcing and the supply of FLASH memory.

4. By storing the software program along with data in FLASH memory not only is the cost of the controller reduced, but the software program is also field changeable and upgradeable.

5. Providing high integration substantially reduces the overall space needed and reduces the complexity and the cost of manufacturing.

Although the present invention has been described in accordance with the embodiments shown, one of ordinary skill in the art will readily recognize that there could be variations to the embodiments and those variations would be within the spirit and scope of the present invention. Accordingly, a FLASH controller in accordance with the present invention applies to a variety of mass storage devices such as Serial ATA FLASH hard drive, IDE FLASH hard drive, SCSI FLASH hard drive and Ethernet FLASH hard drive. In addition, a FLASH controller in accordance with the present invention also applies to FLASH memory cards such as Express Card, Mini PCI Express Card, Secure Digital Card, Multi Media Card, Memory Stick Card and Compact FLASH card. Finally, a FLASH controller in accordance with the present invention also applies to the other serial buses such as PCI Express bus, Serial ATA bus, IEEE 1394 bus and Ethernet bus. Accordingly, many modifications may be made by one of ordinary skill in the art without departing from the spirit and scope of the appended claims.

1. A FLASH controller comprising:
a USB interface unit, wherein USB interface unit implements a USB standard that has a bus speed equal or greater than 12 Mb/s;
an internal bus coupled to the USB interface unit; and
a FLASH interface unit coupled to the internal bus, the FLASH interface unit includes FLASH controller logic that allows the throughput for access to a FLASH memory to match the speed of the USB standard.

2. The FLASH controller of claim 1 wherein the USB standard comprises the USB 2.0 standard.

3. The FLASH controller of claim 1 wherein the software program for the FLASH controller is stored along with data in at least one of the plurality of FLASH memories for cost reduction and field upgrade ability.

4. The FLASH controller of claim 1 wherein the throughput for access to a FLASH memory to match the speed of the USB standard is accomplished by providing a wider bandwidth FLASH data bus.

5. The FLASH controller of claim 1 wherein the throughput for access to a FLASH memory to match the speed of the USB standard is accomplished by providing concurrent internal and external read and write cycles.

6. The FLASH controller of claim 4 wherein the wider data bandwidth is provided by using a FLASH memory with the appropriate data width.

7. The FLASH controller of claim 4 wherein the wider data bandwidth is provided by using multiple FLASH memories.

8. The FLASH controller of claim 1 wherein the throughput for access to a FLASH memory to match the speed of the USB standard is accomplished by providing a wider bandwidth FLASH data bus and concurrent internal and external read and write cycles.

9. The FLASH controller of claim 1 including a FLASH type detection algorithm for determining if a FLASH type is supported by the FLASH controller.

10. The FLASH controller of claim 1 wherein an external power regulator, reset circuit and crystal are integrated via mixed signal technology or Multi-Chip package.

11. A mass storage device comprising:
a FLASH controller further comprising an interface unit, an internal bus coupled to the interface unit; and a FLASH interface unit coupled to the internal bus, the FLASH interface unit includes FLASH controller logic that allows the throughput for access to a FLASH memory to match the speed of the interface unit; and
a plurality of FLASH memories coupled to the FLASH interface unit, wherein the software program for the FLASH controller is stored along with data in at least one of the plurality of FLASH memories for cost reduction and field upgrade ability.

12. The FLASH controller of claim 11, wherein the interface unit comprises a USB interface unit, wherein the USB interface unit implements a USB standard that has a bus speed equal to or greater than 12 Mb/s.

13. The FLASH controller of claim 12 wherein the USB standard comprises the USB 2.0 standard.

14. The FLASH controller of claim 12 wherein the throughput for access to a FLASH memory to match the speed of the USB standard is accomplished by providing a wider bandwidth FLASH data bus.

15. The FLASH controller of claim 12 wherein the throughput for access to a FLASH memory to match the speed of the USB standard is accomplished by providing concurrent internal and external read and write cycles.

16. The FLASH controller of claim 14 wherein the wider data bandwidth is provided by using a FLASH memory with the appropriate data width.

17. The FLASH controller of claim 14 wherein the wider data bandwidth is provided by using multiple FLASH memories.

18. The FLASH controller of claim 12 wherein the throughput for access to a FLASH memory to match the speed of the USB standard is accomplished by providing a wider bandwidth FLASH data bus and concurrent internal and external read and write cycles.

19. The FLASH controller of claim 12 including a FLASH type detection algorithm for determining if a FLASH type is supported by the FLASH controller.

20. The FLASH controller of claim 12 wherein an external power regulator, reset circuit and crystal are integrated via mixed signal technology or Multi-Chip package.

21. The FLASH controller of claim 11 wherein the throughput increase for access to a FLASH memory is accomplished by providing a wider bandwidth FLASH data bus.

22. The FLASH controller of claim 11 wherein the throughput increase for access to a FLASH memory is accomplished by providing concurrent internal and external read and write cycles.

23. The FLASH controller of claim 21 wherein the wider data bandwidth is provided by using a FLASH memory with the appropriate data width.

24. The FLASH controller of claim 21 wherein the wider data bandwidth is provided by using multiple FLASH memories.

25. The FLASH controller of claim 11 wherein the throughput increase for access to a FLASH memory is accomplished by providing a wider bandwidth FLASH data bus and concurrent internal and external read and write cycles.

26. The FLASH controller of claim 11 including a FLASH type detection algorithm for determining if a FLASH type is supported by the FLASH controller.

27. The FLASH controller of claim 11 wherein an external power regulator, reset circuit and crystal are integrated via mixed signal technology or Multi-Chip package.
